(19) United States
(12) Patent Application Publication
(10) Pub. No.: US 2024/0337893 A1
(43) Pub. Date: Oct. 10, 2024

(54) QUANTUM COMPUTER

(71) Applicants: Khanh Le, Bellwood, IL (US); John Lekavich, Bellwood, IL (US); Bao Tran, Saratoga, CA (US)

(72) Inventors: Khanh Le, Bellwood, IL (US); John Lekavich, Bellwood, IL (US); Bao Tran, Saratoga, CA (US)

(21) Appl. No.: 18/132,076

(22) Filed: Apr. 7, 2023

(51) Int. Cl. G02F 1/33; G02F 1/29; G02F 3/00; G06N 10/40

(52) U.S. Cl. CPC G02F 1/33; G02F 1/292; G02F 3/00; G06N 10/40

(57) ABSTRACT

A quantum computer includes a laser source and an acousto-optic deflector that includes an optical element having a surface with one or more steps formed thereon; a conductive layer formed on the surface with the steps; one or more crystals secured to each step; and electrodes positioned on each surface of each crystal.

This application claims priority to co-pending, commonly filed applications on Apr. 7, 2023 with Ser. Nos. ______, 18/132,034, 18/132,047, 18/132,054, 18/132,058, 18/132,064, 18/132,069, 18/132,070, 18/132,074, and, the contents of which are incorporated by reference.

### BACKGROUND

The present invention relates to quantum computing laser system.

Quantum computing is a rapidly developing field of computing technology that makes use of the principles of quantum mechanics to solve complex problems faster and more efficiently than classical computers. Classical computers rely on binary digits or bits to perform computations, which can represent only one of two states (0 or 1) at any given time. In contrast, quantum computers use quantum bits or qubits, which can represent multiple states simultaneously due to the phenomenon known as superposition.

In a quantum computer, quantum bits are manipulated using quantum gates, which are analogous to the logic gates used in classical computers. These gates can perform operations on qubits such as flipping the phase, changing the state, or entangling them. The power of quantum computing comes from the fact that qubits can exist in multiple states simultaneously, allowing quantum computers to perform many calculations in parallel.

One of the most well-known quantum algorithms is Shor's algorithm, which can factor large numbers exponentially faster than classical algorithms. This has significant implications for cryptography, as many cryptographic protocols rely on the fact that factoring large numbers is a difficult problem for classical computers.

One of the primary uses of lasers in quantum computing is for the generation of entangled photon pairs. Entanglement is a fundamental concept in quantum mechanics that allows two or more particles to become intrinsically connected, so that the state of one particle depends on the state of the other. Entangled photons can be used for quantum teleportation, quantum cryptography, and other quantum communication protocols.

Lasers play an important role in many aspects of quantum computing. They are used for creating and manipulating the quantum bits or qubits, which are the basic building blocks of quantum computers. Lasers are also used for detecting and measuring the state of the qubits. Lasers are also used for cooling and trapping atoms and ions, which are the other main systems used for qubits in quantum computers. The cooling and trapping of these particles is essential for controlling and manipulating their quantum states.

Additionally, lasers are used in quantum computing for the readout of qubit states, through a technique known as laser-induced fluorescence. This involves using a laser to excite the qubit, causing it to emit a photon with a specific energy, which can then be detected and measured.

### SUMMARY

In one aspect, a quantum computer system to process a plurality of qubits includes a laser source, an acousto-optic device (AOD), a control circuit, and a memory, wherein the phased array AOD is configured to control the laser beam for addressing each of the plurality of qubits.

Implementations may include one or more of the following. A processor is configured to execute quantum algorithms using the plurality of qubits. The AOD is configured to generate multiple laser beams for simultaneous addressing of multiple qubits. The control circuit is configured to adjust the frequency and phase of the laser beam using the AOD to manipulate the state of each of the plurality of qubits. The AOD is configured to switch between different beams with different frequencies and phases to perform quantum logic gates. The memory is configured to store quantum states of the plurality of qubits. The system can include an optical element having a surface with one or more steps formed thereon; a conductive layer formed on the surface with the steps; one or more crystals secured to each step; and electrodes positioned on each surface of each crystal. A tuning element can be used to match a predetermined impedance using inductive and capacitive passive components. The optical element comprises a slanted end with a compound angle to move reflected sound field out of a laser beam working range, wherein the slanted end forms a 30 degree angle measured from a long side of the optical element to a short side of the optical element and a surface of the slanted end comprises a 2 degree slope. The optical element comprises germanium, tellurium dioxide (TeO2), lithium niobate, PZT, fused silica, chalcogenide glasses, glass.

In another aspect, a method to process data includes: generating a laser beam using a laser source; controlling the laser beam using an acousto-optic device (AOD) applying the laser beam to an optical element having zero or more steps each with a predetermined height and one or more crystals or transducers on the one or more steps; impedance matching the electrical input of the transducers to a predetermined load; providing an electrical input to deflect the laser at the two or more frequencies; generating a sound field in the optical element to deflect a laser beam based on two or more frequencies; addressing a plurality of qubits using the laser beam controlled by the phased array AOD; and manipulating the state of each of the plurality of qubits using the frequency and phase of the laser beam controlled by the AOD.

In implementations, the method includes executing quantum algorithms using the plurality of qubits. The AOD is configured to generate multiple laser beams for simultaneous addressing of multiple qubits. The AOD is configured to switch between different beams with different frequencies and phases to perform quantum logic gates. Quantum states of the plurality of qubits can be stored in a memory. The optical element comprises a slanted end, wherein the slanted end comprises a compound angle to move reflected sound field out of a laser beam working range, wherein the slanted end forms a 30 degree angle measured from a long side of the optical element to a short side of the optical element, and wherein a surface of the slanted end comprises a 2 degree slope. The optical element comprises germanium, tellurium dioxide (TeO2), lithium niobate, PZT, fused silica, chalcogenide glasses, glass.

In another aspect, a quantum computing device to process a plurality of qubits includes
a laser source,
a acousto-optic device (AOD), and
a control circuit, wherein the phased array AOD is configured to control the laser beam for addressing each of the plurality of qubits and the control circuit is configured to execute quantum algorithms using the plurality of qubits.

The AOD may be configured to generate multiple laser beams for simultaneous addressing of multiple qubits and wherein the phased array AOD is configured to switch between different beams with different frequencies and phases to perform quantum logic gates.

In another aspect, an acousto-optic deflector includes an optical element having a surface with one or more steps formed thereon; a conductive layer formed on the surface with the steps; one or more crystals secured to each step; and one or more electrodes positioned on the surface of the one or more crystals.

Implementations of the above aspect can include one or more of the following. A tuning element can be used to match a predetermined impedance. The tuning element can provide an output impedance of 50 ohms for one use case. The tuning element can have inductive and capacitive passive components. In one embodiment, the tuning element can be a 1:1 balun, 4:1 transformer, a capacitor, and an inductor. The optical element comprises a slanted end. The tuning element matches a deflector output impedance at 40 MHz and at 60 MHz to a 50 ohm impedance. The slanted end can have a compound angle designed to drive the reflected sound field out of a laser beam working range so that no reflected sound wave can impact laser performance. In one specific design, the slanted end forms a 30 degree angle measured from a long side of the optical element to a short side of the optical element and the surface of the slanted end has a 2 degree slope. The optical element can be germanium, tellurium dioxide (TeO2), lithium niobate, PZT, fused silica, chalcogenide glasses, or glass, for example.

In another aspect, a method to form a phased-array transducer includes
grinding an optical element to form two or more steps each with a predetermined height;
depositing a conductive layer (gold) over the one or more steps;
attaching one or more crystals or transducers on the one or more steps; and
attaching electrodes to the top and bottom of each transducer.

Implementations of the above aspect can include one or more of the following. The method includes matching the input of the transducers to a predetermined impedance. A tuning element can be connected to the transducers with an output impedance of 50 ohms. The tuning element includes inductive and capacitive passive components. The tuning element can have a 1:1 balun, a 4:1 transformer, a capacitor, and an inductor. The optical element can have a slanted end, wherein the slanted end comprises a compound angle to move reflected sound field out of a laser beam working range. Te slanted end forms a 30 degree angle measured from a long side of the optical element to a short side of the optical element. A surface of the slanted end has a 2 degree slope. The optical element comprises germanium, tellurium dioxide (TeO2), lithium niobate, PZT, fused silica, chalcogenide glasses, glass. The tuning element matches a deflector output impedance at 40 MHz and at 60 MHz to a 50 ohm impedance.

In another aspect, a method to deflect a laser beam includes:
applying the laser beam to an optical element having one or more steps each with a predetermined height and one or more crystals or transducers on the one or more steps;
impedance matching the electrical input of the transducers to a 50-ohm load;
providing an electrical input to deflect the laser at the two or more frequencies; and
generating a sound field in the optical element to deflect a laser beam based on two or more frequencies.

In a further aspect, a method to form an opto-acoustic deflector includes
grinding an optical element to provide one or more steps each with a predetermined height;
depositing a layer of gold over the one or more steps; and
attaching one or more crystals or transducers on the one or more steps.

Implementations of the above aspect can include one or more of the following. The method includes tuning the electrical output for 40 MHz and 60 MHz output. A slanted end is formed on the optical element with a compound angle to move reflected sound field out of a laser beam working range. The slanted end forms a 30 degree angle measured from a long side of the optical element to a short side of the optical element. A surface of the slanted end comprises a 2 degree slope.

In another aspect, a method to form and to operate an opto-acoustic deflector includes:
grinding an optical element to form one or more steps each with a predetermined height;
depositing a conductive layer (gold) over the one or more steps;
attaching one or more crystals or transducers on the one or more steps;
attaching electrodes to the top and bottom of each transducer;
impedance matching the electrical input of the transducers to a 50-ohm load;
receiving an electrical input to deflect the laser at the two or more frequencies; and
generating a sound field in the optical element to deflect a laser beam based on two or more frequencies.

Implementations can include one or more of the following. The method can include tuning the electrical output for 40 MHz and 60 MHz output. The method includes forming a slanted end on the optical element. The metod further includes forming a compound angle to move reflected sound field out of a laser beam working range. The slanted end forms a 30 degree angle measured from a long side of the optical element to a short side of the optical element. A surface of the slanted end comprises a 2 degree slope. The method includes grinding the optical element, which can be germanium, tellurium dioxide (TeO2), lithium niobate, PZT, fused silica, chalcogenide glasses, glass, among others.

Advantages of the system may include one or more of the following. The use of phased array AODs in quantum computing enables precise control and manipulation of the laser beams that are used to interact with the qubits. The ability to switch the laser beams on and off quickly, and to produce complex patterns of laser beams, allows for the precise timing and manipulation of the qubits that is necessary for quantum computing. Phased array AODs offer several advantages for laser control in quantum computing systems. First, they provide rapid and precise control of the laser beam, which is essential for manipulating quantum states with high fidelity. Second, they can be used to implement complex laser pulse sequences, such as those required for quantum error correction and quantum gate operations. Third, they can be integrated with other components of the quantum computing system, such as optical fibers and detectors, to achieve a compact and efficient design. As the field of quantum computing continues to evolve, it is likely that AODs will continue to play an important role in the development of new and more powerful quantum computing. The phased array deflector can operate with two distinct frequencies, for example at 40 and 60 MHz, resulting in a single device that can do the job of two. The deflector thus is smaller, lower power, and higher matching behavior over versions that require two separate deflectors each geared toward a particular frequency. The acousto-optic deflector is a versatile device that provides precise and efficient control over the direction of a laser beam. They offer rapid and precise control of the laser beam, enabling the manipulation of quantum states with high fidelity and efficiency. Additionally, they offer several advantages over other laser control techniques, such as faster and more precise control and high integration with other system components. With further development and optimization, phased array AODs have the potential to play a critical role in the practical implementation of quantum computing systems.

### BRIEF DESCRIPTION OF THE DRAWINGS

FIG. 1A-1B show an exemplary phased array opto-acoustic deflector.

FIG. 2A-2B show exemplary processes for forming and using the deflector of FIG. 1A.

FIG. 3 shows an exemplary tuning element that is coupled to the electrodes to match a predetermined impedance.

FIG. 4 shows an exemplary opto-acoustic laser system.

FIG. 5 shows an exemplary quantum computer.

### DESCRIPTION

Quantum computing is a rapidly evolving field that promises to revolutionize computing as we know it by taking advantage of the properties of quantum mechanics to perform computations that are impossible or impractical using classical computers. Phased array acousto-optic deflectors (AODs) are an important component of many quantum computing systems, used to precisely control and manipulate the laser beams that are used to interact with the quantum bits (qubits) that make up the computer.

At the heart of any quantum computing system are the qubits themselves, which are the fundamental building blocks of quantum information. Qubits can exist in a superposition of states, which means that they can represent both a 0 and a 1 at the same time. This property allows quantum computers to perform certain computations much faster than classical computers, because they can take advantage of the exponentially large number of possible states that can be represented by a given number of qubits.

The precise control of the qubits is essential to the operation of a quantum computer, and this is where the AODs come in. AODs use sound waves to deflect laser beams, allowing them to be precisely controlled and manipulated. The sound waves are generated by applying an electrical signal to a piezoelectric crystal, which causes it to vibrate and produce acoustic waves. These waves are then used to modulate the refractive index of a transparent material, which in turn deflects the laser beam.

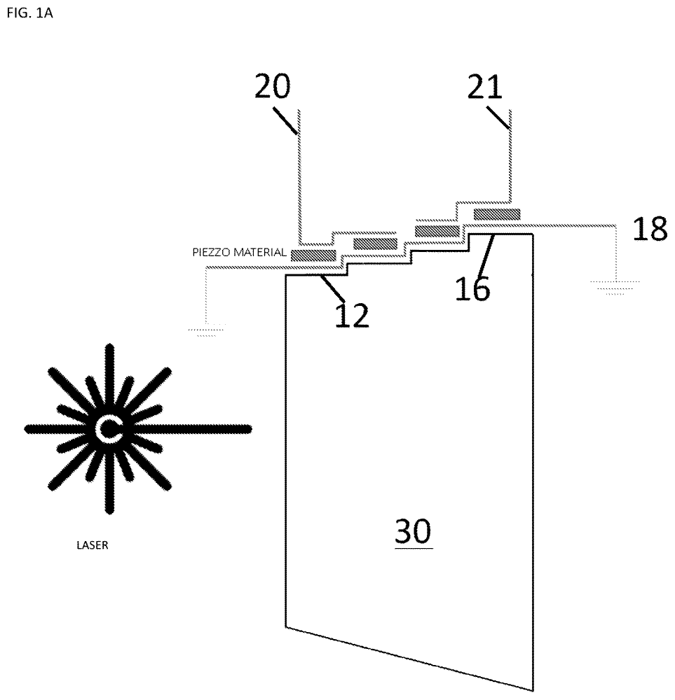

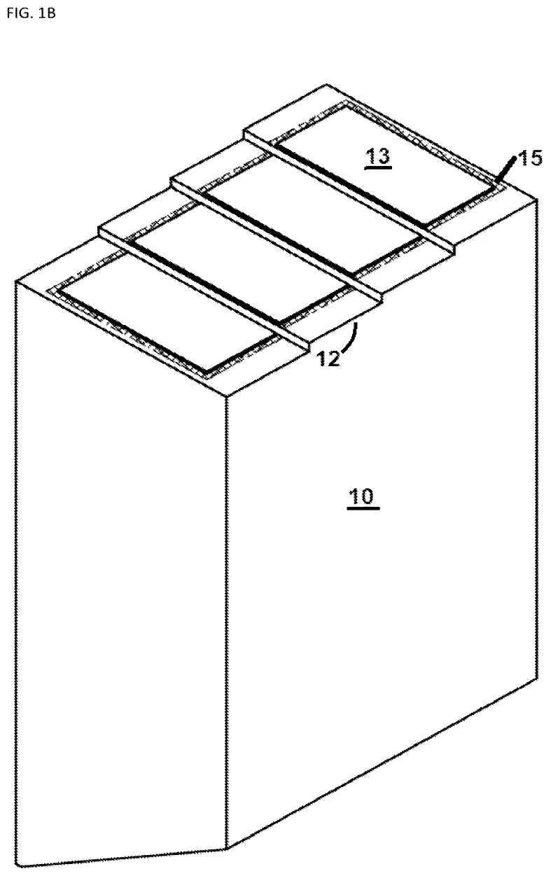

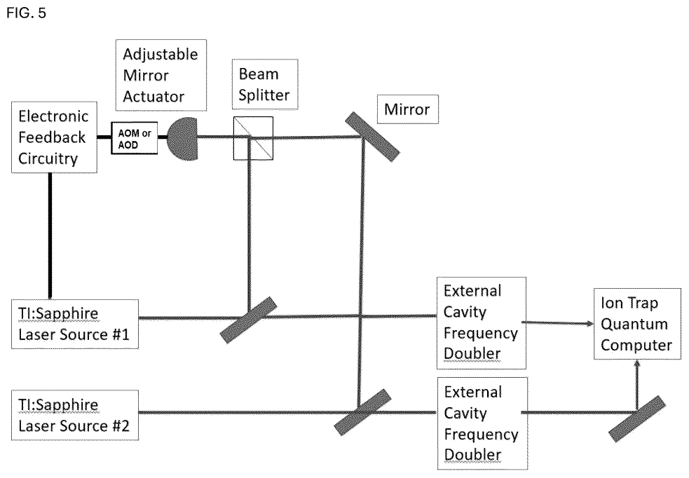

FIG. 5 shows a quantum computing system using the AOD of FIG. 1, where laser beams are used to excite and manipulate the qubits. The beams are focused onto the qubits using high-precision optics, and then deflected and steered using the AODs. The AODs can be used to change the direction of the laser beams, or to split them into multiple beams that can be used to interact with multiple qubits at once. The use of the instant AODs improves quantum computing due to their ability to switch the laser beams on and off very quickly, allowing for precise timing of the interactions between the qubits and the laser beams. This is particularly important for implementing quantum gates, which are the basic building blocks of quantum circuits. Quantum gates are used to perform operations on the qubits, such as entangling them or flipping their states, and precise timing is essential for these operations to work correctly. The phased array AOD can further enhance quantum computing in their ability to produce complex patterns of laser beams that can be used to create intricate interference patterns. These patterns can be used to manipulate the phase of the qubits, which is an important property in quantum computing. By manipulating the phase of the qubits, it is possible to perform a variety of different operations, such as quantum Fourier transforms, which are essential for many quantum algorithms.

In addition to their use in controlling the laser beams used in quantum computing, AODs are also in other parts of the system. For example, they can be used to control the position of optical fibers that are used to carry the laser beams between different parts of the system. They can also be used to control the position of mirrors that are used to reflect the laser beams back onto the qubits, or to control the position of lenses that are used to focus the beams onto the qubits.

The phased array AODs of FIG. 1-5 is ideal for quantum computing for precise control and manipulation of the laser beams that are used to interact with the qubits. The ability to switch the laser beams on and off quickly, and to produce complex patterns of laser beams, allows for the precise timing and manipulation of the qubits that is necessary for quantum computing. As the field of quantum computing continues to evolve, it is likely that AODs will continue to play an important role in the development of new and more powerful quantum computers.

FIG. 1A shows an exemplary phased array opto-acoustic system. In a phased array opto-acoustic system, a pulsed laser beam is used to generate acoustic waves in a sample chamber such as optical element that receives the laser beam. The laser beam path is altered by the sound generated by the opto-acoustic elements in a transducer coupled to the optical element.

FIG. 1A-16 show a device 10 having stepped surfaces 12 and 16 on one end, and an angled end 30 opposite to the stepped surfaces 12 and 16. Turning now to FIG. 1A, an exemplary phase-array device includes an optical element having a surface with one or more steps formed thereon, where the optical element has at least two step heights. The different heights of the steps affect the acousto-optic RF frequency responses.

Transducers are mounted above the stepped surfaces 12 and 16, with one side of each transducer coupled to RF inputs 20-21 respectively, and the other side of the transducer connected to ground 18. The phased array transducer array has a plurality of transducers mounted on a top surface, with each transducer at a different height. Each transducer in the array is positioned at different vertical positions, such as at different heights above a sample chamber surface. One example of such an array is a linear transducer array, in which a linear array of transducers is arranged along a surface, with each transducer positioned at a different height. Another example is a 2D transducer array, in which a grid of transducers is positioned at different heights to form a 2D array.

Phased array AODs use acoustic waves to manipulate the phase of the laser beam, allowing for precise control of its direction and intensity. They consist of a piezoelectric transducer that generates acoustic waves, which are converted into a spatially varying index of refraction in an acousto-optic crystal. This results in a diffraction grating that can deflect the laser beam in different directions, depending on the frequency and phase of the acoustic wave. By using multiple transducers and controlling their phases and frequencies, a phased array AOD can steer the laser beam in any desired direction with high precision.

### Applications in Quantum Computing

Advantages over Other Techniques: Phased array AODs offer several advantages over other laser control techniques. For example, they can provide faster and more precise control of the laser beam than other acousto-optic devices, such as single transducer deflectors. They can also be used to steer the laser beam in two dimensions, which is not possible with other techniques such as electro-optic modulators. Additionally, they offer a high level of integration with other components of the quantum computing system, such as fiber optics and detectors, allowing for a compact and efficient design.

As shown in FIG. 1B, the optical element 10 has a surface with one or more steps 12 formed thereon, where the height of each step on the surface of the optical element can be precisely controlled during the manufacturing process, which allows for the creation of specific acousto-optic frequency responses. The step height can be chosen to match the wavelength of RF input, creating a specific phase shift, or to provide a specific diffraction angle. The height of each step can also affect the coupling between the acoustic wave and the optical wave, which determines the efficiency and bandwidth of the acousto-optic interaction. Grinding or subtractive techniques can be applied to the surface of the optical element to form one or more steps spaced apart on the surface, where the height of each step affects the acousto-optic RF frequency response. This provides a versatile and precise tool for manipulating the interaction between acoustic waves and optical waves. This technology is useful in a variety of applications, such as laser beam modulation, scanning, and frequency shifting.

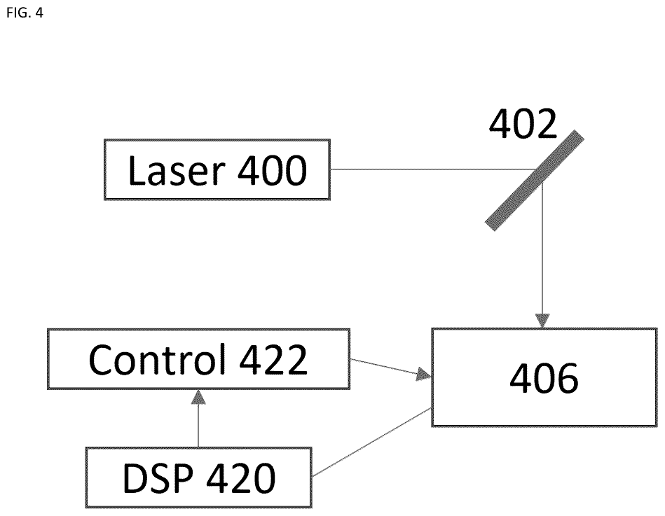

In some cases, the steps 12 on the surface of the optical element can have a plurality of different heights. This can be done to create a more complex RF frequency response, which can be useful for certain applications. Transducer 13 is adhesively bonded with a thin epoxy layer 15 to the top to steps 12. This is done when the device 10 is inserted into its spot in the receptacle of FIG. 4C, applying a thin layer of epoxy 15 on top of step 13, and then by operation of vacuuming the transducer 13 to secure it to the bottom of the piston and by air pressure lowering the piston with the top of step 12 and evenly apply the epoxy to secure the transducer 13 to device 10.

By having steps with different heights, the acousto-optic device can be designed to deflect light at multiple angles or frequencies. This can be used, for example, in laser scanning systems, where the deflection angle of the incident laser beam needs to be precisely controlled.

The optical and acoustic elements in a phased array opto-acoustic device are arranged in a specific pattern to allow for precise control of the acoustic waves generated and detected. The optical elements transmit the laser beam through the sample chamber. The acoustic elements may include a phased array of transducers, which are used to control the direction and intensity of the acoustic waves.

In these applications, the optical element is made of a material that can support a propagating acoustic wave, such as a crystal or glass. The acoustic wave is created by a transducer, and its frequency is modulated by an applied RF signal. The optical element is made of a material that can support a propagating acoustic wave, such as a crystal or glass. The acoustic wave is created by a transducer, and its frequency is modulated by an applied RF signal. the height of each step affects the acousto-optic RF frequency response, is typically used in acousto-optic modulators and deflectors. One embodiment of the instant device enables a single device to work at two distinct frequencies, enabling one device to be used instead of two separate devices.

The optical element has a surface with one or more steps formed thereon, where the height of each step on the surface of the optical element can be precisely controlled during the manufacturing process, which allows for the creation of specific acousto-optic frequency responses. The step height can be chosen to match the wavelength of the incident light, creating a specific phase shift, or to provide a specific diffraction angle. The height of each step can also affect the coupling between the acoustic wave and the optical wave, which determines the efficiency and bandwidth of the acousto-optic interaction.

Grinding or subtractive techniques can be applied to the surface of the optical element to form one or more steps spaced apart on the surface, where the height of each step affects the acousto-optic RF frequency response. This provides a versatile and precise tool for manipulating the interaction between acoustic waves and optical waves. This technology is useful in a variety of applications, such as laser beam modulation, scanning, and frequency shifting.

In some cases, the steps on the surface of the optical element can have a plurality of different heights. This can be done to create a more complex RF frequency response, which can be useful for certain applications.

By having steps with different heights, the acousto-optic device can be designed to deflect light at multiple angles or frequencies. This can be used, for example, in laser scanning systems, where the deflection angle of the incident laser beam needs to be precisely controlled.

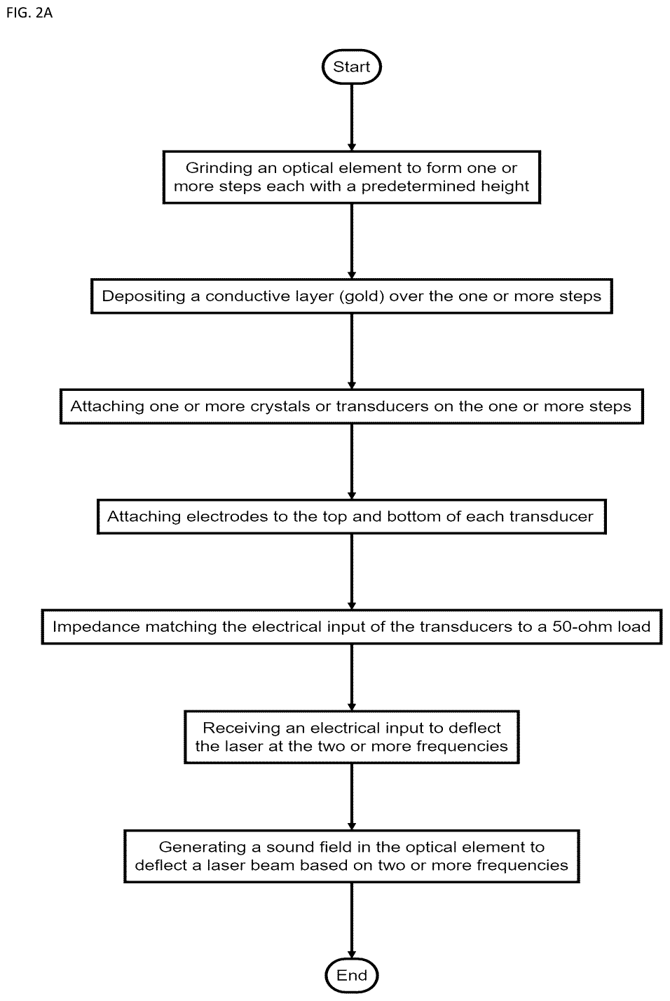

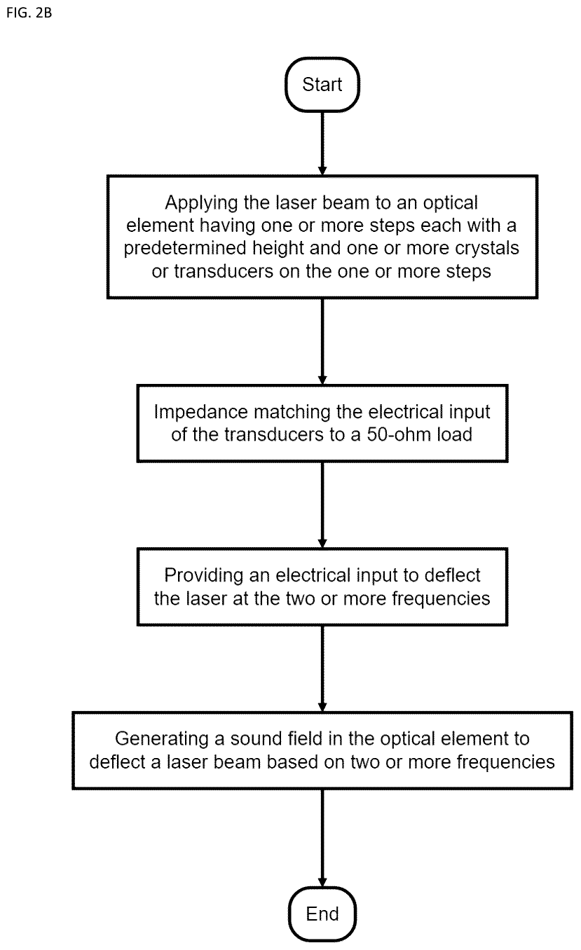

FIG. 2A shows an exemplary process to form a phased-array transducer. The process includes the following operations:
grinding an optical element to form two or more steps each with a predetermined height;
depositing a conductive layer over the one or more steps;
attaching one or more crystals or transducers on the one or more steps; and
attaching electrodes to the top and bottom of each transducer.

In more details, the process of creating steps with different heights on the surface of an optical element can be done using various techniques, including etching or grinding. Etching can be used to selectively remove material from the surface, while grinding can be used to selectively remove material from certain areas of the surface. The end result is a surface with steps of varying heights that can be used to control the RF frequency response of the acousto-optic device.

The tools used to grind the optical element with the steps may vary depending on the material of the optical element and the desired precision of the steps. Some common tools used for grinding optical elements include diamond-tipped tools, abrasive wheels, and lapping/polishing pads.

Diamond-tipped tools are often used for grinding hard and brittle materials such as glass and some ceramics. These tools are made of a thin metal shank with a small diamond grit on the tip. The diamond grit is used to scratch away material from the optical element, creating the desired steps. Diamond-tipped tools can achieve high precision and smooth surface finishes.

Abrasive wheels are another common tool used for grinding optical elements. These wheels are made of abrasive particles bonded to a wheel shape. The abrasive particles can be made of materials such as silicon carbide or aluminum oxide, and the bond can be made of materials such as resin or vitrified ceramic. Abrasive wheels are often used for grinding softer materials such as plastic or some metals. These wheels can remove material quickly but may not achieve the same precision as diamond-tipped tools.

Lapping and polishing pads are used for finishing the optical element after grinding. These pads are made of a soft material such as felt or polyurethane foam and are coated with a fine abrasive material such as diamond paste. The optical element is placed on the pad and moved in a circular motion to achieve a smooth surface finish.

Other tools that may be used for grinding optical elements include grinding machines, CNC equipment, and ultrasonic machining tools. The choice of tool depends on the material of the optical element, the desired precision, and the production volume.

Cleaning of the optical element surface is an essential step to ensure the adhesion of the subsequent gold layer. The cleaning operation typically involves the following steps:
Rinse the optical element with deionized water or a cleaning solvent to remove any loose particles or debris on the surface.
Immerse the optical element in a mild acid solution, such as hydrochloric acid or sulfuric acid, to remove any organic or inorganic contaminants. The duration of the immersion depends on the type and level of contamination and typically ranges from a few seconds to several minutes.
Rinse the optical element with deionized water to remove any residual acid and neutralize the surface.
Dry the optical element using a stream of dry nitrogen or argon gas or a cleanroom-compatible drying method such as spin-drying or vacuum-drying.
Inspect the optical element surface under a microscope or with a cleanroom-compatible surface analysis tool to ensure that the surface is free of particles, scratches, or defects that can affect the performance of the subsequent gold layer deposition.

By following these steps, the optical element surface can be prepared for the deposition of a uniform and adherent gold layer.

The height of each step on the surface of the optical element can be precisely controlled during the manufacturing process, which allows for the creation of specific acousto-optic frequency responses. The step height can be chosen to match the wavelength of the incident sound, creating a specific phase shift, or to provide a specific diffraction angle. The height of each step can also affect the coupling between the acoustic wave and the optical wave, which determines the efficiency and bandwidth of the acousto-optic interaction.

In an acousto-optic modulator, the applied RF signal modulates the frequency of the acoustic wave, which in turn modulates the phase or amplitude of the optical wave passing through the optical element. The modulation depth and frequency bandwidth of the modulator depend on the height and spacing of the steps on the optical element. The applied RF signal generates an acoustic wave that travels along the surface of the optical element, causing the incident optical beam to diffract at a specific angle. The applied RF signal modulates the frequency of the acoustic wave, which in turn modulates the phase or amplitude of the optical wave passing through the optical element.

A conductive layer is formed on the surface with the steps. In some cases, a conductive layer such as gold is deposited on the surface with the steps. This is done to allow for an electrical contact to be made with the surface, which is necessary for applying the RF signal to the acousto-optic device. The conductive layer also helps to reduce any unwanted reflections that may occur at the surface, which can affect the performance of the device.

First, a layer of nichrome is formed on the surface of the optical element since gold does not bond well with the optical element. Then a layer of gold is deposited above the nichrome layer. The conductive layer is typically deposited using a process called physical vapor deposition (PVD) or sputtering. In PVD, a thin film of gold is deposited on the surface by evaporating the metal in a vacuum chamber and allowing it to condense onto the surface. In sputtering, a plasma is used to eject gold atoms from a target material and deposit them onto the surface.

The equipment used to deposit a fine layer of gold over the steps on the optical element is called a physical vapor deposition (PVD) system. PVD is a process where a solid material is vaporized in a vacuum environment, and the resulting vapor condenses onto a substrate to form a thin film.

In this case, the gold is evaporated in a vacuum chamber using an electron beam gun or a resistive filament. The vaporized gold atoms travel in a straight line towards the substrate, where they condense and form a thin layer on the surface of the optical element. The thickness of the gold layer can be controlled by adjusting the deposition rate and the deposition time.

The PVD system typically includes a vacuum chamber, a substrate holder, a source of gold, and a means to evaporate the gold. The substrate holder is designed to hold the optical element with the steps facing upwards and is positioned in the vacuum chamber. The chamber is then evacuated to a high vacuum level, typically in the range of 10\hat{ }−6 to 10\hat{ }−7 torr, to prevent contamination of the gold layer.

The gold source is typically a solid piece of gold that is heated by an electron beam or a resistive filament. As the gold is heated, it evaporates and condenses on the surface of the optical element. The deposition rate and deposition time can be controlled by adjusting the power of the heating source and the distance between the source and the substrate.

Once the gold layer is deposited, the optical element is removed from the vacuum chamber and inspected for uniformity and thickness. The thickness of the gold layer is typically in the range of a few hundred nanometers to a few microns, depending on the application.

Overall, the PVD system is a precise and reliable method for depositing a thin layer of gold on the surface of the optical element with the steps, ensuring optimal performance of the acousto-optic deflector.

A transducer or a crystal is then affixed to each step, preferably at different heights based on the height of the steps. The crystal is secured to each step of an optical element using epoxy bonding in one embodiment. The crystal is placed in contact with the conductive layer on the surface of the optical element. Electrodes positioned on each surface of each crystal, one connected to ground and one connected to an RF signal driving the crystal.

After the conductive layer is deposited and the crystal affixed to the optical element, electrical contacts are typically made to the surface using wire bonding or other techniques. Electrodes are then connected to each side of the crystal. Energy applied to the crystal generates an acoustic wave in response to an applied RF signal, and the electrodes are used to apply the RF signal to the crystal. An RF signal is then applied to the contacts, which generates the acoustic wave that modulates the refractive index of the acousto-optic material and deflects the incident light.

The electrodes are made of a conductive material, such as gold or aluminum, and are placed on opposite sides of the crystal. When an RF signal is applied to the electrodes, it generates an acoustic wave in the crystal, which can then be used to modulate the laser beam applied to the optical element.

An RF signal applied to the crystal would generate an acoustic wave, which would propagate through the crystal and into the optical element. The acoustic wave would then modulate the refractive index of the optical element, causing it to diffract or deflect an incident beam of light.

The positioning and design of the electrodes can be critical to the performance of the acousto-optic device. The spacing between the electrodes, the shape of the electrodes, and the applied voltage all affect the frequency response of the device.

FIG. 2B shows an exemplary method to deflect a laser beam that includes:
applying the laser beam to an optical element having one or more steps each with a predetermined height and one or more crystals or transducers on the one or more steps;
impedance matching the electrical input of the transducers to a 50-ohm load;
providing an electrical input to deflect the laser at the two or more frequencies; and
generating a sound field in the optical element to deflect a laser beam based on two or more frequencies.

Other methods to form an opto-acoustic deflector include:
grinding an optical element to provide one or more steps each with a predetermined height;
depositing a layer of gold over the one or more steps; and
attaching one or more crystals or transducers on the one or more steps.

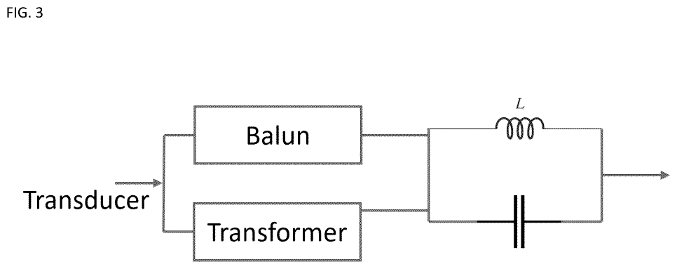

FIG. 3 shows an exemplary tuning element that is coupled to the electrodes to match a predetermined impedance. The tuning element is used to match the predetermined impedance of the acousto-optic phased array transducers. The tuning element is typically an inductor with a predetermined coil length and a variable capacitor or a trimmer capacitor that is adjusted to match the impedance of the system. This is important to ensure maximum power transfer between the amplifier and the acousto-optic deflector, which leads to better performance and efficiency. The tuning element can be adjusted by a technician or can be automated using a feedback control loop to continuously monitor and adjust the impedance.

The tuning element is typically used to match the impedance of the acousto-optic deflector to the impedance of the driving circuit, which is often 50 ohms. This ensures maximum power transfer between the amplifier and the acousto-optic deflector. The impedance matching can help to minimize the reflection of the signal, which can cause unwanted interference and signal degradation.

The tuning element can be used to match the impedance of the acousto-optic deflector at specific RF frequencies to a 50-ohm impedance. This is typically done using a matching network or filter, which can be adjusted to achieve the desired impedance match. For example, if the deflector has an output impedance of 40 MHz and 60 MHz, a tuning element can be designed to match those frequencies to 50 ohms.

The tuning element can be implemented using various techniques, such as a lumped element filter, a distributed element filter, or a combination of both. The choice of technique depends on various factors such as the frequency range, the required bandwidth, and the physical size of the tuning element.

Once the tuning element is designed, it can be coupled to the electrodes of the acousto-optic deflector to achieve the desired impedance match. This can be done using various coupling techniques such as wire bonding or soldering. The impedance match ensures that maximum power is transferred from the RF amplifier to the acousto-optic deflector, which improves its efficiency and performance.

Opposite to the surface with the steps on the optical element is a slanted end with a compound angle to direct any reflected sound field away from the laser beam working range. This can help to reduce unwanted interference and improve the overall performance of the acousto-optic deflector. The compound angle can be designed to achieve the desired deflection angle for the laser beam while also minimizing any unwanted reflections or diffraction effects. The exact design of the slanted end will depend on the specific application and requirements of the acousto-optic deflector.

To prevent these issues, it is important to carefully control the deposition process and ensure that the gold layer is well adhered to the optical element's surface. Additionally, the amount of epoxy used should be carefully controlled and optimized to ensure strong bonding between the crystals and the surface without creating unnecessary attenuation of the acoustic waves. Quality control and testing should also be performed to ensure that the opto-acoustic deflector meets the required specifications for performance and reliability.

To form a slanted end of the optical element with a 30 degree angle measured from a long side to a short side and a surface with a 2 degree slope, the following steps can be taken:
Obtain an optical element made of the desired material, such as germanium or tellurium dioxide (TeO2).
Determine the dimensions of the optical element and mark the area where the slanted end will be located.
Use a precision saw or cutting tool to cut the slanted end at the desired angle. This can be done by tilting the cutting tool at a 30 degree angle relative to the long side of the optical element.
Use a precision grinding tool, such as a diamond or abrasive wheel, to grind the surface of the slanted end to achieve the desired 2 degree slope. This can be done by adjusting the angle and pressure of the grinding tool.
Inspect the surface of the slanted end to ensure that it is smooth and free of any cracks or defects.
Clean the surface of the slanted end using a gentle solvent, such as isopropyl alcohol, to remove any debris or particles.
Optionally, apply a protective coating, such as a thin layer of anti-reflection coating or a metal film, to the surface of the slanted end to improve its optical properties and prevent damage from handling or exposure to the environment.

Overall, the key to forming a slanted end with the desired angle and slope is to use precision tools and techniques to achieve the desired shape and surface quality, while minimizing any damage or stress to the optical element.

The optical element can be germanium, tellurium dioxide (TeO2), lithium niobate, PZT, fused silica, chalcogenide glasses, glass. The choice of material for the optical element depends on various factors such as the desired optical properties, thermal and mechanical stability, and the specific application for which the element will be used.

The choice of crystal for an opto-acoustic laser system depends on the specific application and the properties of the crystal. Some of the factors that are typically considered when selecting a crystal for opto-acoustic applications include the crystal's acoustic and optical properties, as well as its thermal and mechanical stability, among others. One commonly used crystal for opto-acoustic applications is lithium niobate (LiNbO3). LiNbO3 has excellent acoustic properties, with a high acoustic velocity and a low acoustic attenuation, which makes it ideal for generating and detecting acoustic waves. It also has strong nonlinear optical properties, which can be used for frequency conversion and modulation of the laser beam.

Another crystal that is commonly used for opto-acoustic applications is quartz (SiO2). Quartz has a high acoustic velocity and a low acoustic attenuation, making it ideal for acoustic wave generation and detection. It is also highly transparent in the infrared region, which is useful for many laser applications.

Other crystals that are sometimes used for opto-acoustic applications include gallium arsenide (GaAs), gallium nitride (GaN), and sapphire (Al2O3). These crystals have specific properties that make them suitable for certain applications, such as high-temperature stability or high optical nonlinearity.

The choice of crystal for an opto-acoustic laser system depends on the specific requirements of the application, such as the desired acoustic and optical properties, as well as the thermal and mechanical stability of the crystal.

Some commonly used materials for acousto-optic devices include:
Germanium: Germanium is a common material for acousto-optic modulators operating in the mid-infrared region due to its high refractive index and low absorption coefficient in this range.
Tellurium dioxide (TeO2): TeO2 is a widely used material for acousto-optic devices due to its high electro-optic coefficient and wide transparency range from UV to mid-infrared.
Lithium niobate (LiNbO3): LiNbO3 is a well-known electro-optic material with high electro-optic coefficients, making it a popular choice for high-speed acousto-optic modulators and deflectors.
PZT: PZT or lead zirconate titanate is a piezoelectric material with high coupling coefficients, making it an ideal choice for transducers in acousto-optic devices.
Fused silica: Fused silica has a high laser damage threshold and low coefficient of thermal expansion, making it suitable for high-power applications.
Chalcogenide glasses: These are glasses containing elements from the chalcogen group such as sulfur, selenium, and tellurium. They have high refractive indices, wide transparency ranges, and are suitable for acousto-optic devices in the mid-infrared range.
Glass: Different types of glasses can be used for acousto-optic devices depending on the specific application and desired properties. For example, borosilicate glass is commonly used for high-power applications, while crown glass is used for its high refractive index.

Next, a description of the process to form an opto-acoustic deflector is detailed. The operation includes the following:
Grinding the Optical Element: The first step is to grind the optical element to provide one or more steps, each with a predetermined height. This step involves precise grinding to create the desired step heights for optimal acousto-optic performance.
Deposition of Conductive Layer: After grinding, a layer of gold is deposited over the one or more steps of the optical element. To improve bonding of the gold to the optical layer, a layer of nichrome is first deposited on the optical element, and the gold conductive layer is subsequently formed. The gold layer provides a conductive surface that can be used for attachment of the crystals or transducers.
Attachment of Crystals or Transducers: One or more crystals or transducers are attached on the one or more steps of the optical element. These crystals or transducers generate acoustic waves that interact with light passing through the optical element and deflect it in a controlled manner. The attachment process can involve a variety of techniques, such as epoxy bonding, soldering, or mechanical clamping.
Capturing Electrical Output: Electrical signals are generated by the crystals or transducers when they are subjected to acoustic waves. These electrical signals are captured using specialized electronics designed to amplify and process them for further analysis.
Impedance Matching: The final step is to impedance match the electrical output to a 50-ohm load. This involves the use of a tuning element such as a matching network or a transformer, which helps to adjust the impedance of the electrical signal to match the required load. This step is critical to ensure maximum power transfer and minimum signal loss.

Once the impedance matching is complete, the opto-acoustic deflector is ready for use. It can be integrated into various optical systems to deflect and control light with high precision, making it useful for a variety of applications such as laser printing, holography, and optical communication.

In the context of a transducer array with each transducer at a different height, it is possible to achieve the height difference by grinding the surface on which the transducers are mounted to create a stepped profile. This can be accomplished using precision grinding tools and techniques, such as diamond grinding or abrasive blasting.

The grinding process involves removing material from the surface in a controlled manner to create a series of steps or terraces with different heights. The transducers can then be mounted on the surface at the desired heights, with each transducer positioned on a different terrace. The height difference between the transducers can be controlled by adjusting the height and spacing of the terraces during the grinding process.

Grinding can be a precise and effective method for creating a stepped surface with controlled heights for a transducer array. The result of the grinding process forms a set of pedestals to mount transducers to the pedestal array, with at least two transducers with different heights.

Attaching a transducer to a surface of the stpes can be done using an epoxy spread in an even and thin manner. This method involves applying a layer of epoxy or other adhesive material to the surface and then placing the transducer on top of the adhesive. The epoxy is then allowed to cure, creating a strong and permanent bond between the transducer and the surface.

As each transducer may be positioned at a different height, an array of spreaders can be used to apply the epoxy to the surface in a controlled and uniform manner. Each application head can be customized according to the desired height, allowing the epoxy to be applied to specific areas of the surface to create the desired stepped profile. The use of an array of spreaders, each with self adjustable heights, can provide a high degree of control and precision in the placement of the transducers, allowing for a more uniform and consistent array. However, specialized equipment is needed to create and operate the array of individually pliant spreaders so that each spreader automatically conforms to the different step heights.

The array of individually pliant spreaders can be pneumatically actuated to allow for precise control over the height of each transducer in the array. Pneumatic actuation involves using compressed air to control the movement of the spreaders and to stop them at the desired height for each surface portion.

By using pneumatic actuation with the pliant or conformal heads, the spreaders can be controlled to stop at the exact height required for each transducer, allowing for an even spread of the epoxy and a precise positioning of the bonding pressure on the transducers to ensure optimum bond between the transducer and the corresponding step on the optical element. This method can be particularly useful for creating an array with a plurality of transducers, as it allows for the process to be automated and ensures a consistent and accurate result.

The use of pneumatically actuated spreaders also offers other advantages over manual methods, such as greater speed, efficiency, and repeatability. It can also reduce the risk of human error and variability in the epoxy spreading process, which can lead to more consistent and reliable results.

Using pneumatically actuated spreaders to create a transducer array with each transducer at a different height can be a viable option for applications that require precise and uniform positioning of the transducers. The suitability of this method will depend on the specific requirements of the application and the available resources and expertise.

Attaching the crystals or transducers to the layer of gold on the optical element can be done through several methods, including ultrasonic bonding, thermal compression bonding, or epoxy bonding.

Ultrasonic bonding involves placing the crystal or transducer onto the layer of gold and using ultrasonic waves to generate heat and create a bond between the two materials. This method is commonly used for smaller crystals and transducers.

Thermal compression bonding involves applying heat and pressure to the crystal or transducer, causing it to bond with the layer of gold. This method is commonly used for larger crystals and transducers.

Epoxy bonding involves applying a small amount of epoxy adhesive to the crystal or transducer and placing it onto the layer of gold. The adhesive is then cured, creating a strong bond between the crystal or transducer and the gold layer.

Regardless of the method used, care should be taken to ensure that the crystal or transducer is properly aligned with the gold layer to ensure optimal performance of the opto-acoustic deflector.

The thickness of the epoxy layer used to attach the crystals to the layer of gold in an opto-acoustic deflector must be as thin as possible for several reasons:
Minimizing acoustic attenuation: The epoxy layer can attenuate the acoustic wave generated by the transducer, which can reduce the deflection efficiency of the device. A thinner epoxy layer can minimize the attenuation of the acoustic wave and improve the device's performance.
Avoiding acoustic interference: The epoxy layer can also cause acoustic interference, particularly if it is too thick. This interference can result in unwanted diffraction or scattering of the acoustic wave, which can also reduce the device's performance. A thinner epoxy layer can help to avoid this problem.
Minimizing optical distortion: The epoxy layer can also introduce optical distortion due to its refractive index. This distortion can be particularly problematic if the optical element is used in a laser beam steering application where precise control of the beam direction is critical. A thinner epoxy layer can help to minimize this distortion and improve the device's performance.

Overall, a thinner epoxy layer can help to improve the efficiency, accuracy, and reliability of an opto-acoustic deflector.

The process of applying an ultra-thin layer of epoxy involves several steps, including:
Preparation: The surface of the gold layer on the optical element must be thoroughly cleaned to remove any contaminants that may interfere with the adhesion of the epoxy. This can be done using a combination of solvents and ultrasonic cleaning.
Mixing: The epoxy is typically a two-part adhesive that must be mixed together in precise proportions. This is often done using a syringe or other dispensing device to ensure accuracy.
Dispensing: Once mixed, the epoxy is dispensed onto the surface of the gold layer. To achieve an ultra-thin layer, a dispensing device with a small aperture is typically used.
Spreading: The epoxy is spread evenly across the surface of the gold layer using a micro-manipulator or other precision tool. This must be done carefully to avoid creating air bubbles or other imperfections.
Curing: Once the epoxy has been applied, it must be cured according to the manufacturer's instructions. This typically involves heating the optical element to a specific temperature for a set amount of time.

By using precise dispensing and spreading techniques, it is possible to apply an ultra-thin layer of epoxy that is only a few microns thick. This is important for acousto-optic devices because it minimizes any interference that the epoxy layer may have on the performance of the device.

Delamination of the gold layer and epoxy failure can both be potential issues in the manufacturing process of an opto-acoustic deflector. Gold delamination can occur due to poor adhesion between the gold layer and the optical element's surface. This can be caused by inadequate cleaning of the surface before deposition, or by the use of inappropriate conditions during the deposition process. If the gold layer delaminates, it can cause the crystals to detach from the surface, resulting in the failure of the entire device. Epoxy failure can occur due to a number of factors. One issue can be improper mixing of the epoxy, leading to inconsistencies in the hardness and adhesive properties of the epoxy. Another issue can be the use of too much or too little epoxy, which can affect the bonding strength and stability of the crystals. In addition, if the epoxy layer is too thick, it can lead to acoustic wave attenuation, reducing the efficiency of the opto-acoustic deflector.

If the epoxy layer is too thick, it can create several issues in the opto-acoustic deflector. Firstly, a thick layer of epoxy can cause an uneven surface, which can affect the optical properties of the deflector. This can result in distortion, scattering, or attenuation of the laser beam passing through the deflector. Secondly, a thick layer of epoxy can increase the distance between the crystal and the gold layer, which can affect the efficiency of the acousto-optic interaction. This can result in lower deflection efficiency, higher power consumption, or increased heat generation.

Additionally, a thick layer of epoxy can cause mechanical stress on the crystal and the gold layer. As the epoxy cures, it can generate heat and shrink, which can cause the crystal or the gold layer to deform or crack. This can affect the stability, reliability, and lifetime of the opto-acoustic deflector.

To avoid these potential problems, it is important to apply a thin and uniform layer of epoxy on the steps of the deflector surface. This can be achieved by using a precision dispenser, a flat blade or a roller to spread the epoxy evenly. The thickness of the epoxy layer should be controlled within a certain range, depending on the type and viscosity of the epoxy, the height and pitch of the steps, and the required optical and mechanical properties of the deflector. Typically, the thickness of the epoxy layer can be in the range of a few micrometers to tens of micrometers, depending on the application requirements.

In one embodiment, a method for securing crystals to a gold plated optical element includes:
placing each crystal on a moveable pedestal mounted on a piston;
temporarily securing each crystal to the moveable pedestal;
applying an epoxy to a plurality of steps on a deflector surface;
placing the piston with the crystals over the plurality of steps;
actuating the piston and moving each moveable pedestal to contact the crystal with the epoxy;
releasing the crystal from the moveable pedestal; and
curing the epoxy to secure the crystal to the steps.

The method for securing crystals to a gold plated optical element using epoxy involves the following The method for securing crystals to a gold plated optical element using epoxy involves the following steps:
Placing each crystal on a moveable pedestal mounted on a piston: The crystals are carefully placed on a moveable pedestal which is mounted on a piston that is capable of moving up and down.
Temporarily securing each crystal to the moveable pedestal: To prevent the crystals from falling off during the assembly process, they are temporarily secured to the moveable pedestal using a small amount of wax or adhesive.
Applying an epoxy to a plurality of steps on a deflector surface: A small amount of epoxy is applied to a plurality of steps on the deflector surface. It is important to apply the epoxy thinly and evenly to avoid any inconsistencies in the final assembly.
Placing the piston with the crystals over the plurality of steps: The piston, with the crystals mounted on the moveable pedestals, is carefully lowered over the plurality of steps on the deflector surface.
Actuating the piston and moving each moveable pedestal to contact the crystal with the epoxy: The piston is actuated to move each moveable pedestal, and the crystals are brought into contact with the epoxy on the steps of the deflector surface.
Curing the epoxy to secure the crystal to the steps: Once the crystals are in place, the epoxy is cured. This is typically done by heating the assembly to a specific temperature for a specified amount of time. The curing process ensures that the crystals are securely attached to the deflector surface.

It is important to note that the entire assembly process should be carried out in a clean environment, free of dust and other contaminants, to avoid any potential issues with the final product. Additionally, care should be taken to ensure that the crystals are properly aligned with the deflector surface to avoid any misalignment issues during use.

Due to the steps with variable heights, the piston is a gimbal that can move in x and y axis to apply controlled pressure to the crystals and to spread the epoxy as thin as possible. The use of a gimbal allows for precise movement of the piston in both the x and y directions, which helps to ensure that each crystal is pressed evenly onto the deflector surface even where different step heights are involved, and that the epoxy is spread evenly across the steps. This is important for achieving a strong and reliable bond between the crystals and the deflector surface, as well as for ensuring that the crystal positions are aligned correctly. The gimbal can also be used to adjust the pressure and angle of the crystals, which can be important for optimizing the performance of the opto-acoustic deflector.

FIG. 4 shows an exemplary opto-acoustic laser system, which is a type of system that combines optical and acoustic techniques for a range of applications, such as sensing, imaging, and spectroscopy. Some of the main components of an opto-acoustic laser system include:
Laser source 400: A laser source is used to generate the optical radiation that interacts with the sample. Different types of lasers can be used, depending on the specific application, such as pulsed or continuous wave (CW) lasers.
Optical components: 402 Optical components are used to guide, focus, and manipulate the laser beam. These may include mirrors, lenses, polarizers, and filters.
Acoustic transducers 406: Acoustic transducers are used to generate and detect acoustic waves that are produced by the interaction of the laser beam with the sample. These can be piezoelectric transducers, optical fibers, or other types of sensors. A sample chamber is the region where the laser beam interacts with the sample. Preferably the sample chamber is inside an optical element such as element 10 of FIG. 1, but in other applications the sample chamber can be a gas cell, a liquid cell, or a solid-state sample holder, depending on the application.
Signal processing and data acquisition 420: Signal processing and data acquisition systems are used to analyze the acoustic signals generated by the interaction of the laser beam with the sample. These systems may include amplifiers, filters, and data acquisition cards.
Control electronics 422: Control electronics are used to synchronize the laser and acoustic pulses, as well as to control the various components of the system, such as the laser power, acoustic frequency, and detection settings.

The phased array opto-acoustic system is a type of opto-acoustic imaging system that uses an array of optical and acoustic elements to generate and detect acoustic waves for imaging and sensing applications.

When an RF frequency acoustic wave propagates inside an optically transparent medium, a periodic change in the refractive index occurs due to the compressions and rarefactions of the sound wave. This periodic variation produces a grating capable of diffracting an incident laser beam.

Two types of diffraction can occur:
Operation as a Raman-Nath device occurs when the laser beam enters the sound field at normal incidence and the light-sound interaction length L<Λ²/A, where A is
the laser wavelength in the medium and Λ is the sound wavelength which is analogous to the line spacing of a thin diffraction grating. Klein and Cook¹ have defined a parameter Q

$$Q = 2 πλ {LF}^{2} / {nV}^{2}$$

where Fis the RF acoustic frequency, n the index of refraction, and V the acoustic velocity of the interaction medium, For a Q value of approximately 4 or less operation is said to be in the Raman-Nath region. Operation in this mode is characterized by the fact that many diffracted orders are generated and the maximum amount of light in any of the diffracted orders is limited to approximately 35 percent. This type of device is typically used as a loss modulator for intracavity applications that require light to be removed from the zero order or undiffracted beam passing straight through the device; for applications such as q-switching.
Operation as a Bragg device occurs when L>Λ²/λ or according to Klein-Cook when Q is approximately 7 or greater. In this mode the incident laser beam should enter the sound field at the Bragg angle

$${θ}_{B} = λ / 2 Λ$$

Maximum diffraction efficiency occurs when the incident laser beam and the first order diffracted beam are adjusted to form symmetrical angles with respect to the acoustic wavefronts. Depending upon design, up to 90 percent of the incident light can be diffracted into one order. Since acousto-optic devices are not 100 percent efficient, all of the light cannot be removed from the zero order. Since no light remains in the first order when the sound power is removed, the first diffracted order is used in applications such as amplitude modulation which require a high extinction ratio.

Amplitude modulation is detailed next Beam separation or angular deviation between zero and first order is twice the Bragg angle

$$θ = 2 {θ}_{B} - λ F / V$$

The separation is proportional to acoustic frequency with a higher center frequency giving greater separation. The percentage of light 1₁ in the first order or diffraction efficiency is given by

$$η = {I}_{1} / I = {sin}^{2} ( {2.22 [ 1 / {λ}^{2} ( L / H ) {M}_{2} {P}_{a} ]}^{1 / 2} )$$

Diffraction efficiency is proportional to acoustic power (Pa), acousto-optic interaction material figure of merit (M2), sound field length to height aspect ratio (UH), and inversely proportional to the square of the optical wavelength (1/0.2).

Since the diffraction process is a sin² function please note that it is possible to overdrive the modulator resulting in decreased diffraction efficiency. Also note that since efficiency is inversely proportional to optical wavelength, longer wavelengths will require more RF drive power (P), and shorter wavelengths will require less RF drive power. Drive power can be determined for optical wavelengths different from the test condition wavelength by

$${P}_{1} / {P}_{2} = {k ( {λ}_{1} / {λ}_{2} )}^{2}$$

Rise time, Tr, is the time interval for the light intensity to go from 10% to 90% of maximum value in response to an acoustic step function. Rise time for a Gaussian laser beam is given by

$$Tr = 0.64 D / V = 0.64 T$$

where Tis the transit time of the acoustic wave across a laser beam of diameter D.

The frequency response of an acousto-optic modulator can be characterized by the modulation index or depth of modulation (M) which can be calculated for a sinusoidal input

$$M = exp ( - {π}^{2} {f}_{m}^{2} {r}^{2} / 8 ) .$$

The 50% depth of modulation or −3 db modulation bandwidth occurs when fmT=0.75 where fm is modulation frequency.

When viewing photodiode current (see FIG. 5) on an oscilloscope, the Depth of Modulation can be calculated from the maximum intensity (Imax) and minimum intensity (Imin) readings displayed

$$M = ( I max - I min ) / ( I max + I min )$$

or in terms of contrast (C) where

$$C ≡ {I}_{max} / {I}_{min}$$

$$M = ( C - 1 ) / ( C + 1 ) .$$

Optical frequency shifting can be done. Because the acoustic wave travels across the optical beam, the optical frequency undergoes a Doppler shift by an amount equal to the acoustic frequency. The Modulator can up-shift or down-shift the optical frequency depending on the orientation of the optical beam in relation to the sound field. If the laser beam enters the sound field at the Bragg angle in opposition to the direction of the sound field, the optical frequency is up-shifted (plus first order) and if the beam enters at the Bragg angle in the same direction as the sound field, the optical frequency is down-shifted (minus first order).

Deflection is detailed next. Since the angular position of the first order beam is proportional to acoustic frequency, an incremental frequency change will produce an incremental angular deviation

$$Δθ = λΔ F / N$$

Total deviation is limited by the transducer electrical bandwidth.

Deflector resolution N, the number of resolvable beam positions across the total scan angle is defined as the total scan angle divided by the diffraction spread of the laser beam. For a uniformly illuminated optical beam

$$N = ( λΔ F / V ) / ( λ / D ) = ( D / V ) Δ F = T Δ F$$

Since r is the transit time of the acoustic wave across the beam diameter D and IIF is the RF bandwidth of the device, the product of the two is called Time Bandwidth product. Since r is the time for sound to fill or clear the optical aperture, it limits the spot position access time in a random access application.

The far field light intensity pattern for the deflected beam is a (sin x/x)2 function. By the Rayleigh Criterion the above resolution occurs when the maximum intensity at one beam position coincides with the intensity minimum at an adjacent beam position.

Changing frequency from the nominal center RF frequency to deflect the laser beam destroys the Bragg angle symmetry condition for efficient diffraction efficiency, resulting in reduced diffraction efficiency at the edges of the scan bandwidth. Incorporating acoustic phased array beam steering in the deflector design will maintain a high diffraction efficiency across the total deflection bandwidth since the acoustic wavefronts effectively rotate in response to a change in frequency to maintain the proper Bragg condition. Acoustic phased array beam steering is accomplished by mechanically cutting into the glass a series of small steps which are one half of an acoustic wavelength high at center frequency and phasing adjacent piezoelectric transducers 180 degrees apart. This technique causes the acoustic wavefronts to effectively rotate in response to a change in applied RF frequency. Because of the beam steering high uniform diffraction efficiency occurs only on one side of the zeroth order beam as the RF frequency is swept from minimum to maximum. On the opposite side of zero order the Bragg condition is satisfied for only one frequency. As the RF frequency is repetitively swept across the entire range, the position for high diffraction efficiency will change in response to mechanically rotating the deflector.

In linear scanning applications where T, total scan time, is short, a frequency gradient is produced across the optical aperture. The frequency gradient acts like a cylinder lens of fixed focal length fl=V T/68, either converging or diverging the diffracted beam. If total scan time is short, the cylinder effect will preclude bi-directional scanning. The effect can be compensated for in a unidirectional fixed scan rate system by adjusting the beam shaping optics used to expand D for resolution purposes.

Multiple beam generation is detailed next. Every acoustic frequency in an acousto-optic device defines a unique angular beam position. If several acoustic frequencies are applied simultaneously to the acousto-optic device, a corresponding number of diffracted beams will be created.

Separation between beams is

$$Δθ = λΔ F / V$$

where ΔF is the acoustic frequency difference between diffracted beams. Each beam can be modulated independently but the intensities of the beams are interrelated.

One AOD deflector embodiment operates at 40 MHz and 60 MHz with high efficiency and equal intensity. Optical grade, single crystal Germanium is used for the interaction medium and Lithium Niobate piezoelectric transducers are used to generate the RF frequency acoustic traveling wave inside the Germanium.

The RF center frequency of operation is 50 MHz and the height of the sound field or active aperture is 10 mm. RF frequencies of operation are 40 MHz and 60 MHz. The Germanium optical surfaces are coated with a multi-layer dielectric antireflection coating designed for operation at 9.4 μm. In this embodiment, the pulse rise time, Tr (10% to 90%), and depth of modulation are determined by the light beam diameter D. For Model AGD-5147 with acoustic velocity V=5.5 mm/μsec

$$Tr = 117 D nsec$$

where D is in mm. Modulation response for sinusoidal inputs can be calculated as

$$M = exp ( - 4.08 \times {10}^{- 2} {D}^{2} {f}_{m}^{2} )$$

where D is beam diameter in mm and fm is modulation frequency in MHz. For a deflector, a large beam width is required to obtain full resolution. This precludes operation as a high speed modulator.

The frequency shift range is plus or minus 40 MHz to 60 MHz depending on whether the plus or minus diffracted order is used. The Deflector produces two first order, diffracted, optical beams with an angular separation of 34.2 mad. At 9.4 u , a frequency deviation of 20 MHz centered at 50 MHz will produce an angular separation of 34.2 milliradians centered 85.4 milliradians from the undeflected light. The two optical beams can be individually amplitude modulated.

The optical beam is aligned parallel to the sound field and adjust the vertical position to assure that the total optical beam is in the sound field. Initially, set the device 10 optical face nearly normal to the light beam, apply 50 watts RF power at 60 MHz and rotate the device to adjust the Bragg angle so that optimum first order light intensity is obtained. Change RF frequency to 40 MHz with 50 watts RF power and note the diffraction efficiency. The 40 MHz and 60 MHz efficiencies should be close. Slightly adjust the Bragg angle condition so that equal intensities are obtained at both RF frequencies. After equal intensities are obtained, adjust RF drive power to 120 Watts. Once again check both efficiencies. A slight adjustment may be needed to obtain equal intensities. The zero and unwanted diffraction orders can be spatially filtered with an aperture.

The device of FIG. 1 can be used in a number of applications. For example, the device can be used in laser modulators and deflectors which are devices used in laser systems to modify the behavior of laser beams. The laser modulator is a device that changes the properties of a laser beam as it propagates through a medium. It can be used to control the intensity, phase, or polarization of the beam. The modulators can be made using materials that have nonlinear optical properties, such as lithium niobate, which allows for the manipulation of the laser beam. The laser deflector is a device that changes the direction of a laser beam. It can be used to steer the beam to a particular location or to scan the beam over a surface.

FIG. 5 shows an exemplary quantum computer such as an ion trap quantum computer. An ion trap quantum computer is a type of quantum computer that uses ions as qubits (quantum bits) to perform computations. The ions are usually confined in a trap and manipulated using lasers. Laser light is used to control the state of the qubits by inducing transitions between energy levels of the ions. The laser light is typically focused onto the ions using a lens or a mirror. The frequency of the laser light must be carefully tuned to match the energy difference between the desired energy levels of the ion. This can be achieved using a tunable laser, which can be adjusted to emit light at different frequencies.

The laser light is generated using a laser source, such as a diode laser or a solid-state laser. The laser light is then directed to the ions using a series of mirrors and lenses. The laser light can be modulated using an electro-optic modulator or an acousto-optic modulator to perform specific quantum operations. The laser light can be modulated using an electro-optic modulator (EOM) or an acousto-optic modulator (AOM), but can also be done with the AOD. The modulator can be used to change the intensity or phase of the laser light, which can be useful for performing certain types of quantum operations.

In an ion trap quantum computer, the ions are usually confined using a combination of electric and magnetic fields. The qubits are then manipulated using laser light, which is focused onto the ions using a lens or a mirror. The laser light can be used to perform a variety of quantum operations, such as single-qubit rotations, two-qubit gates, and measurements. The laser in an ion trap quantum computer is used to manipulate the state of the qubits, allowing quantum computations to be performed. The AOM can be used to modulate the laser light to perform specific quantum operations, making it a critical component of the control circuit for the quantum computer.

Quantum computers using phased array AODs rely on precise control of the laser beam direction and frequency. The control circuitry is responsible for coordinating the laser and AOD to perform the desired quantum computations.

The control circuitry typically consists of a computer or microcontroller that interfaces with the AOD and laser through digital and analog signal lines. The computer sends digital signals to the AOD driver to control the frequency and phase of the sound waves generated by the AOD. These sound waves are used to create a diffraction grating that controls the direction of the laser beam.

In addition to controlling the AOD, the control circuitry also interfaces with the laser through an analog signal line. This allows the computer to modulate the laser's intensity and frequency to perform quantum computations.

A qubit can be described as a two-level system in which two states may exist in stable superposition. Consider, for example, two energy states in an atom: a ground state or an excited state. 1). These states are separated by a discrete energy gap, which can be combined using laser radiation at a particular frequency (where the frequency and laser energy are related via Planck's constant h). In other words, the phase relationship between laser radiation and the state of an atom is well-defined. It is possible to create superposition states between the two atomic energy levels by using laser pulses of controlled frequency and duration. This allows a programmer to control the likelihood of finding the atom either in the excited or ground states.

The qubit can be measured and collapse into the excited or ground states with some probability. It can also be reverted back to a standard zero or one value. It is possible to combine multiple two-level systems and create entangled state, where the value one qubit has an effect on the value another. Quantum logic gates are constructed using precisely tuned laser pulses to control the coherent interaction. This is similar to how conventional computers use Boolean logic to process bits.

A sequence of quantum gates that operate on one or more qubits are used to implement quantum algorithms in a quantum computer. The fidelity of a quantum logic gates can be used to measure the probability that a gate works as intended. Fidelity simply means the probability of successful entanglement between two state. Gate errors and corruption of quantum calculations can occur if fidelity falls below a threshold. Quantum gate fidelity can be limited by the ability to control parameters of laser pulses that interact with qubits. This is why optical sources that are very pure and low-noise are essential for the construction of practical, scalable quantum computers.

The optical qubit is a type of qubit that relies on single trapped atoms. An ion trap is a design that uses atomic energy levels to ensure that the excited state lasts as long as possible. Current systems can only do this for a few seconds. Realizing practical optical qubits is not easy. There are many research challenges. Laser linewidth is one of the most important. It sets a maximum coherence time for interactions between qubit and laser source. A quantum computer must complete all calculations in order to take advantage of superposition properties. This is similar to when your phone's battery runs out. You only have a short time to finish your work before your phone dies, and your calculation must stop.

To enable longer calculations, it is desirable to increase coherence time in quantum systems. To achieve a long-excited state life, laser sources must have extremely narrow emission lineswidths. This range is far lower than that of standard laser systems which have linewidths ranging from a few hundred kilohertz up to several megahertz. High-finesse laser cavities require significant linewidth reduction and stabilization. They are sensitive to small vibrations and other noise sources. Advanced linewidth reduction systems can use Ti:sapphire Lasers at 729 nm center wavelength. They have a 1 Hz linewidth and feedback stability from an external optical cavity. This allows for high-fidelity qubit logic gates that are entangled. Ion traps can also be made using a steel vacuum chamber that has been cooled to −450° F. A dozen lasers of slightly different frequencies are directed in this chamber to ionize a mixture of calcium and strontium. These atoms are then held in an electrical field and formed a crystal.

Laser cooling calcium and strontium are performed using the same optical spectrum frequencies. This simplifies the requirements for the laser system. Infrared light can be used to manipulate this material system. There are many available laser sources for this purpose, unlike other materials that need ultraviolet frequencies to excite or trap ions. These devices can produce power of up to one watt, although specifications may vary. Strontium and calcium energy state can become entangled. This makes it possible to read the state of one qubit by interrogating the crystal using a laser wavelength that only interacts with the calcium ion. The calcium/strontium crystal has a 94% fidelity, which is sufficient to show that this concept can be used for quantum computations. Variations on this structure have reached a fidelity of almost 99%, one of the highest gate fidelities ever reported.

Hyperfine qubits, an alternative method to encode information, encodes information at two levels of the ground state alkali-earth material. Coherent coupling via stimulated Raman transformations is possible with two laser frequencies that are separated by only a few gigahertz. The ability to control coherence in this instance is not determined by the linewidths of the lasers, but the relative phase noise between them. These two sources can typically be achieved by phase locking two lasers to maintain an exact frequency offset. You can also use electro-optic modulation to generate two frequencies using sideband generation. Raman transitions can be non-resonant which means that high-fidelity logic gates require a high level of optical power. This system is typically low in phase noise, but requires high power, often at ultraviolet wavelengths.

The control circuitry for quantum computers using phased array AODs is responsible for coordinating the laser and AOD to perform the desired quantum computations. This involves precise control of the laser beam direction and frequency through the use of digital and analog signal lines. The control circuitry initializes the qubits, applies quantum gates to perform the computation, and reads out the result of the computation using measurement gates.

The quantum computing process begins with initializing the quantum state of the system. This involves preparing the qubits (quantum bits) to be in a known state. The qubits are typically initialized to the ground state, which is the lowest energy state of the system. Once the qubits are initialized, the control circuitry begins the quantum computation by applying a series of quantum gates to the qubits. Quantum gates are operations that manipulate the state of the qubits to perform the desired computation. These gates can be implemented by modulating the laser and AOD in specific ways to perform operations such as phase shifting, rotation, and entanglement.

To read the result of the computation, the control circuitry applies a measurement gate to the qubits. This causes the quantum state of the qubits to collapse into a classical state, which can be read out using conventional electronic circuits.

Throughout the quantum computation process, the control circuitry ensures that the laser and AOD are properly synchronized and that the qubits remain coherent. Any errors in the synchronization or coherence can lead to errors in the computation.

In the context of optics, modulation refers to the process of intentionally modifying a signal (e.g., light) by varying one or more of its properties, such as amplitude, frequency, or phase. This can be used for a variety of purposes, including deflection and shifting of the signal. For example, in acousto-optic modulation, a signal is deflected or shifted by using an AOD to apply a varying acoustic wave to a crystal, which in turn alters the refractive index and deflects or shifts the light passing through it. Similarly, in electro-optic modulation, a voltage is applied to a crystal to change its refractive index and modulate the light passing through it. These types of modulation can be used in a variety of applications, such as telecommunications, signal processing, and laser machining.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A quantum computer system to process a plurality of qubits, comprising:
a laser source,
a phased array acousto-optic deflector (AOD) with an optical element having a surface with one or more steps formed thereon, the phased array AOD applying sound generated by one or more piezo materials to direct a laser beam,
a control circuit, and
a memory, wherein the phased array AOD is configured to control the laser beam for addressing each of the plurality of qubits.

2. The system of claim 1, further comprising a processor configured to execute quantum algorithms using the plurality of qubits.

3. The system of claim 1, wherein the phased array AOD is configured to process multiple qubits.

4. The system of claim 1, wherein the control circuit is configured to adjust the frequency and phase of the laser beam using the phased array AOD to manipulate the state of each of the plurality of qubits.

5. The system of claim 1, wherein the phased array AOD is configured to switch between different beams with different frequencies and phases to perform quantum logic gates.

6. The system of claim 1, wherein the memory is configured to store quantum states of the plurality of qubits.

7. The system of claim 1, wherein the phased array AOD comprises:
a conductive layer formed on the surface with the steps coupled to one or more piezo materials; and
electrodes positioned on each surface of each piezo material.

8. (canceled)

9. The system of claim 1, wherein the phased array AOD comprises an optical element with a slanted end with a compound angle to move reflected sound field out of a laser beam working range, wherein the slanted end forms a 30 degree angle measured from a long side of the optical element to a short side of the optical element and a surface of the slanted end comprises a 2 degree slope.

10. The system of claim 1, wherein the phased array AOD comprises an optical element made from one of: germanium, tellurium dioxide (TeO2), lithium niobate, PZT, fused silica, chalcogenide glasses, glass.

11.-18 (canceled)

19. A quantum computing device to process a plurality of qubits, comprising:
a laser source to generate a laser beam,
an acousto-optic device (AOD) including an optical element having a surface with one or more steps formed thereon applying sound generated by one or more piezo materials to direct the laser beam, and
a control circuit, wherein the phased array AOD is configured to control the laser beam for addressing each of the plurality of qubits and the control circuit is configured to execute quantum algorithms using the plurality of qubits.

20. The quantum computing device of claim 19, wherein the AOD is configured to generate multiple laser beams for simultaneous addressing of multiple qubits and wherein the phased array AOD is configured to switch between different beams with different frequencies and phases to perform quantum logic gates.
